(19) United States
(12) Patent Application Publication
(10) Pub. No.: US 2023/0237632 A1
(43) Pub. Date: Jul. 27, 2023

(54) ELECTRONIC DEVICE AND OPERATING METHOD THEREOF

(71) Applicant: SAMSUNG ELECTRONICS CO., LTD., Suwon-si (KR)

(72) Inventors: Jongin LEE, Suwon-si (KR); Sehyun KIM, Suwon-si (KR); Kilsoo CHOI, Suwon-si (KR)

(21) Appl. No.: 18/111,005

(22) Filed: Feb. 17, 2023

Related U.S. Application Data
(63) Continuation of application No. PCT/KR2023/001013, filed on Jan. 20, 2023.

(30) Foreign Application Priority Data
Jan. 21, 2022 (KR) 10-2022-0009237

(51) Int. Cl. G06T 7/00; G06V 10/74

(52) U.S. Cl. CPC G06T 7/0002; G06V 10/761; G06T 2207/30168

(57) ABSTRACT

An electronic device and an operating method of the electronic device are provided. The electronic device includes: a communication interface comprising communication circuitry, a memory storing one or more instructions, and a processor, when executing the one or more instructions stored in the memory, is configured to: while content is executed, identify an execution condition of the content, select a frame-processing mode between an image quality-preference mode and an input lag-preference mode, based on the identifying of the execution condition, the image quality-preference mode being a frame-processing mode in which processing is performed by taking into account image quality of the content preferentially to an input lag of the content, and the input lag-preference mode being a frame-processing mode in which processing is performed by taking into account the input lag of the content preferentially to the image quality of the content, and perform image-quality processing on frames of the content based on the selected frame-processing mode.

### CROSS-REFERENCE TO RELATED APPLICATIONS

This application is a continuation of International Application No. PCT/KR2023/001013 designating the United States, filed on Jan. 20, 2023, in the Korean Intellectual Property Receiving Office and claiming priority to Korean Patent Application No. 10-2022-0009237, filed on Jan. 21, 2022, in the Korean Intellectual Property Office, the disclosures of which are incorporated by reference herein in their entireties.

### BACKGROUND

### Field

The disclosure relates to an electronic device and an operating method thereof, and for example, to an electronic device for adaptively processing quality of an image depending on a content execution condition and an operating method of the electronic device.

### Description of Related Art

Content, such as a game, etc., executed by interactively responding to a user input, requires a high response speed. When a user input is received in a game application, an input lag denotes a time from a point at which the user input is processed to a point at which a processing result screen is output. As image-quality processing of game content by a display device increases, the quality of an output screen may improve, but an input lag may increase.

When content frames are processed only by taking into account an input lag, image-quality processing may not be appropriately performed, and thus, image quality may deteriorate, and when the content frames are processed only by taking into account image quality, an input lag may occur, and thus, a user experience with respect to a game environment may be disturbed.

Therefore, there is a need for a method of adaptively processing content frames according to an execution condition of content, while the content is executed, in order to reduce an input lag, while not reducing the image quality.

### SUMMARY

Embodiments of the disclosure provide an electronic device for reproducing content by adaptively adjusting the quality of image of the content according to an execution condition of the content, and an operating method of the electronic device.

According to an example embodiment of the disclosure, an electronic device includes: a communication interface comprising communication circuitry, a memory including one or more instructions, and a processor configured by executing the one or more instructions stored in the memory to: while content is executed, identify an execution condition of the content, select a frame-processing mode between an image quality-preference mode and an input lag-preference mode based on the identifying of the execution condition, the image quality-preference mode being a frame processing mode in which processing is performed by taking into account image quality of the content preferentially to an input lag of the content, and the input lag-preference mode being a frame processing mode in which processing is performed by taking into account the input lag of the content preferentially to the image quality of the content, and perform image-quality processing on frames of the content according to the selected frame-processing mode.

The processor may further be configured to: determine whether or not there is a change in the execution condition by comparing a feature of one or more recent frame images of the executed content with a feature of one or more previous frame images of the executed content.

The processor may further be configured to: determine whether a difference between a feature value obtained with respect to the one or more recent frame images and a feature value obtained with respect to the one or more previous frame images exceeds a threshold value, based on the difference exceeding the threshold value, change a current frame-processing mode by determining that there is the change in the execution condition and based on the difference not exceeding the threshold value, maintain the current frame-processing mode by determining that there is no change in the execution condition.

The feature value obtained with respect to the one or more recent frame images may include a feature value obtained from an average of information about the one or more recent frame images, and the feature value obtained with respect to the one or more previous frame images may include a feature value obtained from an average of information about the one or more previous frame images.

The feature value may include at least one of a structural similarity index map (SSIM), a peak signal-to-noise ratio (PSNR), or a color histogram.

A number of frame images used for obtaining the feature value, a period for determining whether there is the change in the execution condition of the content, and the threshold value may be differently set depending on a title or a genre of the executed content.

The processor may further be configured to: select the frame-processing mode based on a frequency of inputs received in a determination period of the executed content.

The frequency of the inputs may include a number of times the inputs are received in the determination period and an interval between the inputs received in the determination period.

The processor may further be configured to: based on the number of times of the inputs received in the determination period being greater than a threshold value of a number of times of the input lag-preference mode, and the interval between the inputs being less than a threshold value of an interval of the input lag-preference mode, select the input lag-preference mode, and based on the number of times of the inputs received in the determination period being less than a threshold value of a number of times of the image quality-preference mode, and the interval between the inputs being less than a threshold value of an interval of the image quality-preference mode, select the image quality-preference mode.

The threshold value of the number of times of the input lag-preference mode, the threshold value of the interval of the input lag-preference mode, the threshold value of the number of times of the image quality-preference mode, and the threshold value of the interval of the image quality-preference mode may be differently set depending on a title or a genre of the executed content.

The processor may further be configured to: based on the selected frame-processing mode being the image quality-preference mode, perform a specified number of image quality-enhancing operations on the frames of the content, and based on the selected frame-processing mode being the input lag-preference mode, remove one or more image quality-enhancing operations from among the specified number of image quality-enhancing operations and perform remaining image quality-enhancing operations on the frames of the content.

The processor may further be configured to: based on the executed content being streamed from a server, provide information about the selected frame-processing mode to the server, and receive, from the server, content frames on which image-quality processing is performed based on the selected frame-processing mode.

The processor may further be configured to: determine whether there is a change of scene based on features of frame images of the executed content, based on determining that there is the change of scene, detect a frequency of inputs received in a determination period of the executed content, and based on the frequency of the inputs received in the determination period, select one frame-processing mode between the image quality-preference mode and the input lag-preference mode.

According to an example embodiment of the disclosure, a method of operating an electronic device includes: while content is executed, identifying an execution condition of the content, selecting a frame-processing mode between an image quality-preference mode and an input lag-preference mode, based on the identifying of the execution condition, the image quality-preference mode being a frame-processing mode in which processing is performed by taking into account image quality of the content preferentially to an input lag of the content, and the input lag-preference mode being a frame-processing mode in which processing is performed by taking into account the input lag of the content preferentially to the image quality of the content, and performing image-quality processing on frames of the content based on the selected frame-processing mode.

According to an example embodiment of the disclosure, a non-transitory computer-readable recording medium may have recorded thereon a program including one or more instructions which, when executed by a computer, cause an electronic device, to perform operations including: while content is executed, identifying an execution condition of the content, selecting one frame-processing mode between an image quality-preference mode and an input lag-preference mode, based on the identifying of the execution condition, the image quality-preference mode being a frame-processing mode in which processing is performed by taking into account image quality of the content preferentially to an input lag of the content, and the input lag-preference mode being a frame-processing mode in which processing is performed by taking into account the input lag of the content preferentially to the image quality of the content, and performing image-quality processing on frames of the content based on the selected frame-processing mode.

According to various example embodiments of the disclosure, the latency of content may be precisely controlled, and thus, users may be provided with content reproduction, in which the quality of image of content may be maintained without the inconvenience of an input lag, according to an execution condition of the content.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an environment, in which a method, performed by an electronic device, of reducing latency is applied, according to various embodiments;

FIG. 2 is a block diagram illustrating an example configuration of an electronic device according to various embodiments;

FIG. 3 is a block diagram illustrating an example configuration of an electronic device according to various embodiments;

FIG. 4 is a flowchart illustrating an example method, performed by an electronic device, of processing frames of content according to an execution condition of the content, according to various embodiments;

FIG. 5 is a flowchart illustrating an example method, performed by an electronic device, of processing content frames based on a change in a scene, according to various embodiments;

FIG. 6 is a diagram illustrating examples of one or more recent frame images and one or more previous frame images, obtained by an electronic device, according to various embodiments;

FIG. 7 is a block diagram illustrating an example configuration and operation of a signal processor processing a frame, according to various embodiments;

FIG. 8 is a flowchart illustrating an example method, performed by an electronic device, of processing content frames based on a user input frequency, according to various embodiments;

FIG. 9 is a diagram illustrating a frequency of user inputs received in a determination period of content, according to various embodiments;

FIG. 10 is a flowchart illustrating an example method, performed by an electronic device, of processing frames of content by taking into account of both a change of scene and a user input frequency, according to various embodiments;

FIG. 11 is a block diagram illustrating an example configuration of a server computer providing content to an electronic device, according to various embodiments;

FIG. 12 is a signal flow diagram illustrating an example method, performed by a server computer, of providing information about a frame-processing mode to an electronic device, according to various embodiments; and

FIG. 13 is a signal flow diagram illustrating example operations in which an electronic device provides information about a frame-processing mode to a server computer, and the server computer processes content frames according to the information about the frame-processing mode and transmits the content frames to the electronic device, according to various embodiments.

### DETAILED DESCRIPTION

Throughout the disclosure, the expression “at least one of a, b or c” indicates only a, only b, only c, both a and b, both a and c, both b and c, all of a, b, and c, or variations thereof.

The terms used herein will be briefly described and then the disclosure will be described in greater detail.

In the disclosure, general terms that have been widely used nowadays are selected, when possible, in consideration of functions of the disclosure, but non-general terms may be selected according to the intentions of technicians in the this art, precedents, or new technologies, etc. Some terms may be arbitrarily selected and used. In this case, the meanings of these terms will be explained in corresponding parts of the disclosure. Thus, the terms used herein should be defined not based on the names thereof but based on the meanings thereof and the whole context of the disclosure.

Throughout the disclosure, it will be understood that when an element is referred to as “including” another element, the element may further include other elements unless mentioned otherwise. Also, the terms, such as “unit” or “module,” used in the disclosure, should be understood as a unit that processes at least one function or operation and that may be embodied in a hardware manner, a software manner, or a combination of the hardware manner and the software manner.

Hereinafter, various example embodiments of the disclosure will be described in greater detail with reference to the accompanying drawings. However, the disclosure may have different forms and should not be construed as being limited to the various example embodiments of the disclosure described herein. In the drawings, parts not related to descriptions may be omitted for the clear description of the disclosure, and throughout the disclosure, like reference numerals refer to like elements.

The term “user” in embodiments of the disclosure described herein may denote a person controlling a function or an operation of a computing device or an electronic device using a controller and may also denote a viewer, a manager, or an installing technician.

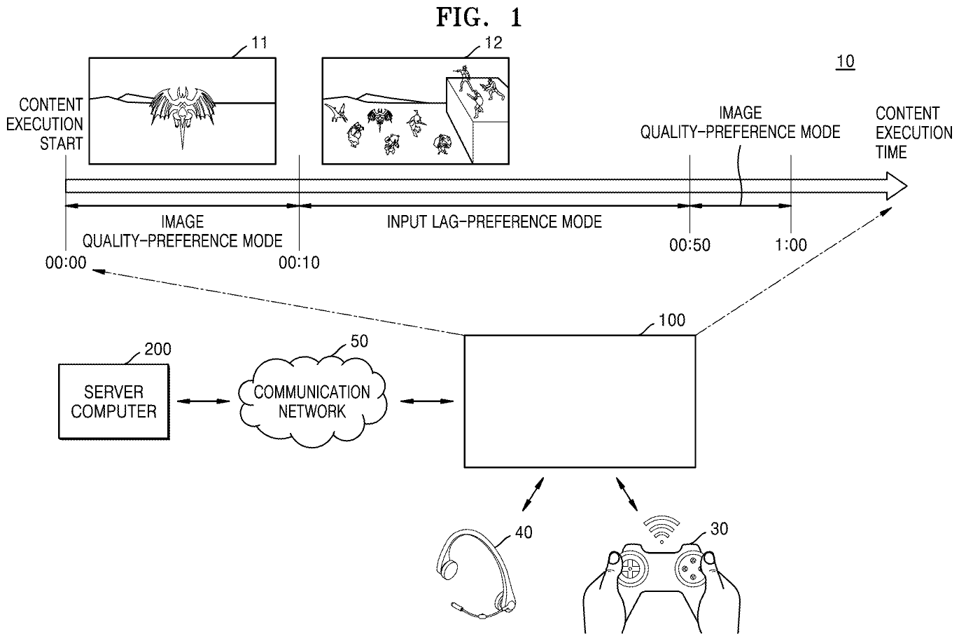

FIG. 1 is a diagram illustrating an environment 10, in which a method, performed by an electronic device 100, of reducing latency is applied, according to various embodiments.

Referring to FIG. 1, the environment 10 may include the electronic device 100, a communication network 50, and a server computer 200.

The server computer 200 may be connected with the electronic device 100 through the communication network 50.

The server computer 200 may be an entity capable of providing various types of content. When the server computer 200 receives a request for content from the electronic device 100, the server computer 200 may provide the requested content to the electronic device 100 through the communication network 50. Various types of content may include, for example, video content, audio content, real time bi-directional communication service content, etc. The real time bi-directional communication service content may indicate content provided through a real time bi-directional communication service, with the server computer 200 providing content to the electronic device 100, receiving control data controlled by a user of the electronic device 100 and performing an operation corresponding to the control data. The real time bi-directional communication service content may include, for example, game content, or video content in which a story or a scenario is changed according to control by a user.

The electronic device 100 may indicate a device capable of displaying various content and may receive a user's request for execution of content and execute and display the requested content in response to the request for execution of content. For example, the content may include game content. The game content may include video content and audio content. The electronic device 100 may display, on a display of the electronic device 100, the video content included in the game content. The electronic device 100 may output the audio content included in the game content through a speaker provided in the electronic device 100 or an audio output device, for example, a headset 40, connected with the electronic device 100. The user of the electronic device 100 may play a game by controlling the game content by watching the game content displayed on the display of the electronic device 100. The user may control the game content using various controllers. For example, the user of the electronic device 100 may control the game content using a game controller 30 wirelessly connected with the electronic device 100 for communication.

The electronic device 100 may indicate a device including a display and being capable of displaying image content, video content, game content, graphics content, etc. The electronic device 100 may include various types of electronic devices capable of receiving and outputting content, such as, for example, and without limitation, a network television (TV), a smart TV, an Internet TV, a web TV, an Internet protocol TV (IPTV), a personal computer (PC), etc. The electronic device 100 may be referred to as an electronic device in terms of the aspect that the electronic device 100 may receive and display content, and the electronic device 100 may also be referred to as a content receiving device, a sync device, a computing device, etc.

The electronic device 100 may display various types of real time bi-directional communication service content. The real time bi-directional communication service content may include, for example, game content.

When the electronic device 100 receives a request for execution of content from a user, the electronic device 100 may reproduce the content requested to be executed. For example, when the content is game content, a delay, that is, latency, may occur, according to a time between a point at which the electronic device 100 receives a control input of the user and a point at which the electronic device 100 processes and displays the content according to the control input of the user. The latency includes not only a time taken by the electronic device 100 to perform image quality processing, like a decoding speed, etc., but also a time taken by the server computer 200 to process the content in order to transmit the content to the electronic device 100 and a time taken for the server computer 200 to transmit the content to the electronic device 100, when the content requested to be executed is the content displayed by a real time bi-directional communication service between the electronic device 100 and the server computer 200.

In the case of a game, etc., a time delay may occur, from an input of a key of a game controller until a response corresponding to the input key is displayed on a screen. This phenomenon may be referred to as an input lag, and as the input lag increases, latency that is experienced by the user may increase. When frames of the content are processed only by preferentially taking into account the input lag, image quality may deteriorate, and when frames of the content are processed only by preferentially taking into account the image quality, latency felt by the user may increase.

Even in one piece of content, there may be a scene for which image quality is important and there may be a scene for which an input lag is important, depending on a story or a progression condition of the content. For example, in the piece of content, for a scene in which an object simply moves, many user inputs may not be required, and thus, the importance of image quality may increase. Also, in the same piece of content, for a scene in which characters battle with each other, a response speed according to a user input may be important, and thus, an input lag may be more important than the image quality.

As described above, even one piece of content may include the scenes having different scene features, and thus, according to the disclosure, an electronic device is provided for adaptively performing frame processing according to the scene features depending on an execution condition of the content. By not just uniformly performing frame processing according to a category of content, but by differently performing frame processing even on one piece of content, depending on the execution condition of the content, users may be provided with an execution environment, in which image quality may not decrease, while at the same time an input lag may not occur, by adaptively processing the image quality and the input lag according to a progression condition of the content.

According to various embodiments of the disclosure, the electronic device 100 and the server computer 200 may provide an “image quality-preference mode,” in which processing of image quality is relatively more important than input latency, and an “input lag-preference mode,” in which the input latency is considered preferentially to the image quality. In the image quality-preference mode, the electronic device 100 may perform all or most of a plurality of image quality processing operations included in image quality processing of content frames. In the input lag-preference mode, the electronic device 100 may omit one or more image quality processing operations from among the plurality of image quality processing operations included in the image quality processing of the content frames, in order to reduce the time taken for the image quality processing. For example, as illustrated in FIG. 1, in scene 11 of content, which shows simple movement of characters, and with respect to which there are not many user inputs, content frames may be processed according to the image quality-preference mode. For example, as illustrated in FIG. 1, in scene 12 of the content, in which there are many interactions among characters, and accordingly, many user inputs, content frames may be processed according to the input lag-preference mode.

According to an embodiment of the disclosure, while the electronic device 100 executes content, the electronic device 100 may determine an execution condition of the content.

According to an embodiment of the disclosure, the electronic device 100 may determine whether there is a change in the execution condition, based on whether there is a change in a scene of the executed content.

According to an embodiment of the disclosure, the electronic device 100 may determine whether there is a change in the scene of the executed content, by comparing a feature of one or more recent frame images with a feature of one or more previous frame images in the executed content.

According to an embodiment of the disclosure, the electronic device 100 may determine whether a difference between a feature value obtained with respect to the one or more recent frame images and a feature value obtained with respect to the one or more previous frame images exceeds a threshold value, and when the difference exceeds the threshold value, the electronic device 100 may determine that there is a change in the execution condition and may change a current frame-processing mode, and when the difference does not exceed the threshold value, the electronic device 100 may determine that there is no change in the execution condition and may maintain the current frame-processing mode.

According to an embodiment of the disclosure, the feature value obtained with respect to the one or more recent frame images may include a feature value obtained from an average of information about the one or more recent frame images, and the feature value obtained with respect to the one or more previous frame images may include a feature value obtained from an average of information about the one or more previous frame images.

According to an embodiment of the disclosure, the feature value may include at least one of a structural similarity index map (SSIM), a peak signal-to-noise ratio (PSNR), or a color histogram.

According to an embodiment of the disclosure, the number of frame images used for obtaining the feature value, a period for determining whether there is a change in the execution condition of the content, and the threshold value may be differently set according to a title or a genre of the executed content.

According to an embodiment of the disclosure, the electronic device 100 may select the frame-processing mode based on a frequency of inputs received in a determination period of the executed content.

According to an embodiment of the disclosure, when the number of times of the inputs received in the determination period is greater than a threshold value of the number of times of the input lag-preference mode, and an interval between the inputs is less than a threshold value of an interval of the input lag-preference mode, the electronic device 100 may select the input lag-preference mode, and when the number of times of the inputs received in the determination period is less than a threshold value of the number of times of the image quality-preference mode, and the interval between the inputs is less than a threshold value of an interval of the image quality-preference mode, the electronic device 100 may select the image quality-preference mode.

According to an embodiment of the disclosure, the threshold value of the number of times of the input lag-preference mode, the threshold value of the interval of the input lag-preference mode, the threshold value of the number of times of the image quality-preference mode, and the threshold value of the interval of the image quality-preference mode may be differently set depending on a title or a genre of the executed content.

According to an embodiment of the disclosure, the electronic device 100 may determine whether there is a change of scene based on features of the frame images of the executed content, and when it is determined that there is the change of scene, the electronic device 100 may select one frame-processing mode between the image quality-preference mode and the input lag-preference mode, based on the frequency of the inputs received in the determination period of the executed content.

According to an embodiment of the disclosure, based on the determining of the execution condition as described above, the electronic device 100 may select one frame-processing mode between the image quality-preference mode in which image quality is preferentially processed to an input lag of the content and the input lag-preference mode in which the input lag is preferentially processed to the image quality of the content, and based on the selected frame-processing mode, may perform image quality processing on the frames of the content.

According to an embodiment of the disclosure, when the selected frame-processing mode is the image quality-preference mode, the electronic device 100 may perform a predetermined (e.g., specified) number of image quality processing operations on the frames of the content, and when the selected frame-processing mode is the input lag-preference mode, the electronic device 100 may remove one or more image quality processing operations from among the predetermined number of image quality processing operations and perform the remaining number of image quality processing operations on the frames of the content.

According to an embodiment of the disclosure, when the executed content is the content streamed from the server computer 200, the electronic device 100 may provide, to the server computer 200, information about the selected frame-processing mode, and may receive, from the server computer 200, the content frames on which image processing is performed based on the selected frame-processing mode.

According to various embodiments of the disclosure, when content is executed, an execution condition of the content may be determined, based on a change of scene or a frequency of inputs with respect to the content, and thus, a frame-processing mode indicating how to perform image quality processing on the content may be adaptively selected and executed. Referring to FIG. 1, from a point at which execution of content is started to a point of 00:10, a scene of the content corresponds to a condition in which movement is freely made using a moving device, and thus, the image quality-preference mode may be selected to process a high quality image, and from the point of 00:10 to a point of 00:50, a scene corresponds to a condition in which processing in response to frequent user inputs is required, e.g., in an urgent battle situation, and thus, the input lag-preference mode may be selected to provide a high response speed with respect to the user inputs. From the point of 00:50 to a point of 1:00, the image quality-preference mode may be selected again, and the content may be processed according thereto.

As described above, according to various example embodiments of the disclosure, when content is executed, different frame-processing modes may be applied depending on a scene feature or an execution condition of the content. Thus, image quality processing may be preferentially performed in a condition in which image quality is important, so that a high quality image may be provided to a user, and frames may be processed such that a response time is taken into account preferentially to image quality, in a condition in which input latency is important, so that a fast image without an input lag may be provided to the user.

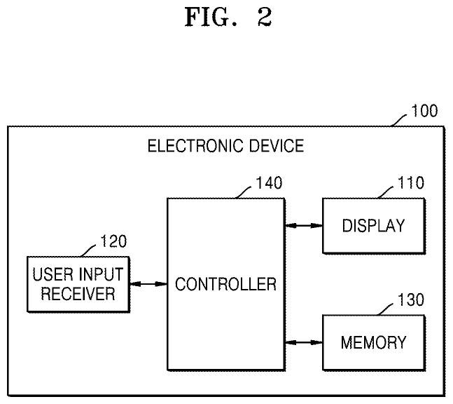

FIG. 2 is a block diagram illustrating an example configuration of the electronic device 100 according to various embodiments.

Referring to FIG. 2, the electronic device 100 may include a display 110, a user input receiver (e.g., including various circuitry) 120, a memory 130, and a controller (e.g., including processing and/or control circuitry) 140.

The display 110 may display content executed according to control by the controller 140.

The display 110 may include a display panel and a controller controlling the display panel and may indicate a display equipped in the electronic device 100. The display panel may be various forms of displays, such as, for example, and without limitation, a liquid crystal display (LCD), an organic light-emitting diode (OLED) display, an active-matrix (AM)-OLED display, a plasma display panel (PDP), etc.

The user input receiver 120 may include various circuitry, including, for example, one or more user input interfaces for receiving user inputs that are provided to control the electronic device 100 or the execution of content displayed on the display 110. For example, the user input receiver 120 may include a user inputter 121 provided in an area of the electronic device 100, a communicator 150 receiving an input from a controlling device controlling the electronic device 100, and a detector 190 sensing an input from the controlling device controlling the electronic device 100.

The memory 130 may store a program connected with operations of the electronic device 100 and various pieces of data generated during the operations of the electronic device 100.

The memory 130 may include at least one type of storage medium from among a flash memory type, a hard disk type, a multimedia card micro type, a card type memory (e.g., an SD or an XD memory), random-access memory (RAM), static RAM (SRAM), read-only memory (ROM), electrically erasable programmable ROM (EEPROM), programmable ROM (PROM), a magnetic memory, a magnetic disk, or an optical disk.

The controller 140 may include various processing and/or control circuitry and control general operations of the electronic device 100 and may execute an instruction stored in the memory 130 to perform the operations of the electronic device 100 described in this disclosure. The controller 140 may include RAM storing a signal or data input from the outside of the electronic device 100 or used as a storage area corresponding to various operations performed by the electronic device 100, ROM in which a control program for controlling a peripheral device is stored, and a processor. The processor may be implemented as a system on chip (SoC) in which a core (not shown) is integrated with a graphics processing unit (GPU) (not shown). Also, the processor may include a plurality of processors.

The controller 140 according to an embodiment of the disclosure may execute one or more instructions to: determine an execution condition of content when the content is executed; select, according to the determining of the execution condition, one frame-processing mode between an image quality-preference mode in which processing is performed by taking into account image quality preferentially to an input lag of the content and an input lag-preference mode in which processing is performed by taking into account the input lag preferentially to the image quality of the content; and perform image quality processing on frames of the content according to the selected frame-processing mode.

The controller 140 according to an embodiment of the disclosure may execute one or more instructions to determine whether there is a change in the execution condition by comparing a feature of one or more recent frame images with a feature of one or more previous frame images of the executed content.

The controller 140 according to an embodiment of the disclosure may execute one or more instructions to: determine whether a difference between a feature value obtained with respect to the one or more recent frame images and a feature value obtained with respect to the one or more previous frame images exceeds a threshold value; when the difference exceeds the threshold value, determine that there is the change in the execution condition and change a current frame-processing mode; when the difference does not exceed the threshold value, determine that there is no change in the execution condition and maintain the current frame-processing mode. The feature value obtained with respect to the one or more recent frame images may include a feature value obtained from an average of information about the one or more recent frame images, and the feature value obtained with respect to the one or more previous frame images may include a feature value obtained from an average of information about the one or more previous frame images. The feature value may include at least one of an SSIM, a PSNR, or a color histogram.

The controller 140 according to an embodiment of the disclosure may execute one or more instructions to differently set the number of frame images used for obtaining the feature value, a period for determining whether there is a change in an execution condition of the content, and the threshold value, depending on a title or a genre of the executed content.

The controller 140 according to an embodiment of the disclosure may execute one or more instructions to select the frame-processing mode based on a frequency of inputs received in a determination period of the executed content.

The controller 140 according to an embodiment of the disclosure may execute one or more instructions to: select the input lag-preference mode when the number of times of the inputs received in the determination period is greater than a threshold value of the number of times of the input lag-preference mode, and an interval between the inputs is less than a threshold value of an interval of the input lag-preference mode; and select the image quality-preference mode when the number of times of the inputs received in the determination period is less than a threshold value of the number of times of the image quality-preference mode, and the interval between the inputs is less than a threshold value of an interval of the image quality-preference mode.

The controller 140 according to an embodiment of the disclosure may execute one or more instructions to differently set the threshold value of the number of times of the input lag-preference mode, the threshold value of the interval of the input lag-preference mode, the threshold value of the number of times of the image quality-preference mode, and the threshold value of the interval of the image quality-preference mode, depending on a title or a genre of the executed content.

The controller 140 according to an embodiment of the disclosure may execute one or more instructions to: perform a predetermined (e.g., specified) number of image quality processing operations on the frames of the content, when the selected frame-processing mode is the image quality-preference mode; and remove one or more image quality processing operations from among the predetermined number of image quality processing operations and perform the remaining number of image quality processing operations on the frames of the content, when the selected frame-processing mode is the input lag-preference mode.

When the executed content is content streamed from the server computer 200, the controller 140 according to an embodiment of the disclosure may execute one or more instructions to provide, to the server computer 200, information about the selected frame-processing mode and receive, from the server computer 200, content frames on which image quality processing is performed based on the selected frame-processing mode.

The controller 140 according to an embodiment of the disclosure may execute one or more instructions to: determine, based on a feature of frame images of the executed content, whether there is a change of scene; and when it is determined that there is the change of scene, select one frame-processing mode between the image quality-preference mode and the input lag-preference mode, based on a frequency of inputs received in a determination period of the executed content.

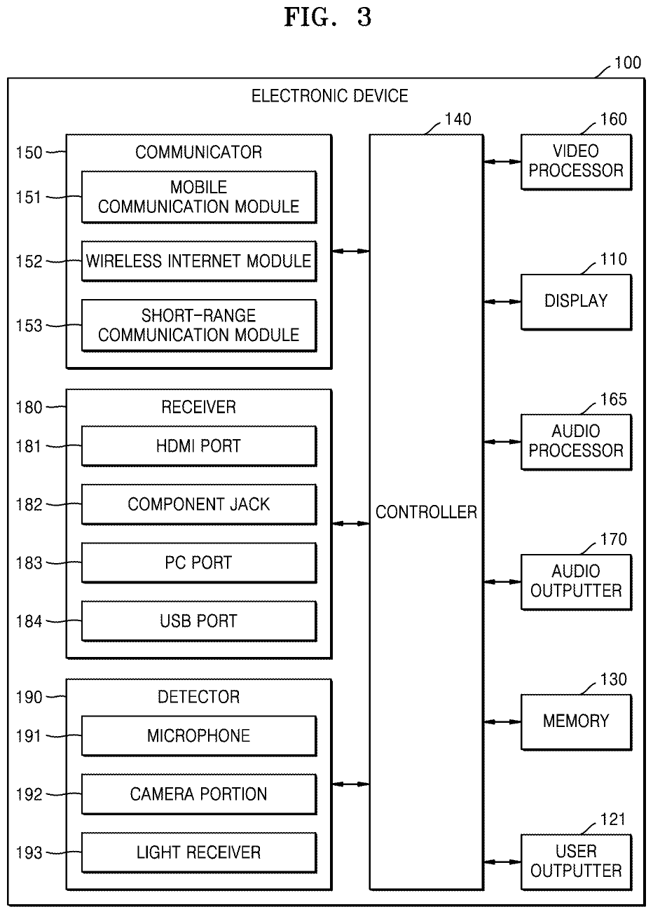

FIG. 3 is a block diagram illustrating an example configuration of the electronic device 100 according to various embodiments.

Referring to FIG. 3, the electronic device 100 may further include the communicator (e.g., including communication circuitry) 150, a video processor (e.g., including video processing circuitry) 160, an audio processor (e.g., including audio processing circuitry) 165, an audio outputter (e.g., including audio output circuitry) 170, a receiver (e.g., including various receiving circuitry) 180, and a detector (e.g., including various detecting circuitry) 190, in addition to the display 110, the user inputter 121, the memory 130, and the controller 140.

The user inputter 121 (e.g., 120 in FIG. 2) may include various circuitry and denote a device via which a user may input data for controlling the electronic device 100. For example, the user inputter 121 may include a key pad, a dome switch, a touch pad (a touch capacitance method, a pressure resistive-layer method, an infrared sensing method, a surface ultrasonic conduction method, an integral tension measurement method, a piezoelectric effect method, etc.), a jog wheel, a jog switch, etc., but is not limited thereto.

The communicator 150 may include various communication circuitry included in one or more modules enabling wireless communication between the electronic device 100 and a wireless communication system or between the electronic device 100 and a network in which another electronic device is arranged. For example, the communicator 150 may include a mobile communication module 151, a wireless Internet module 152, and a short-range communication module 153.

The mobile communication module 151 may include various communication circuitry and transceive a wireless signal with at least one of a base station, an external terminal, or a server, on a mobile communication network. The wireless signal may include a sound call signal, a video-telephony call signal, or various forms of data based on transmission and reception of text/multimedia.

The wireless Internet module 152 may include various communication circuitry and refer to a module for wireless Internet connection and may be embedded in a device or provided as an external component of the device. For wireless Internet technologies, wireless local area network (WLAN) (or Wifi), wireless broadband (Wibro), world interoperability for microwave access (Wimax), high speed downlink packet access (HSDPA), etc. may be used. Through the wireless Internet module 152, the electronic device 200 may form Wifi peer to peer (P2P) connection with another electronic device.

The short-range communication module 153 may include various communication circuitry and refers to a module for short-range communication. For short-range communication technologies, Bluetooth, Bluetooth low energy (BLE), radio frequency identification (RFID), infrared data association (IrDA), ultra wideband (UWB), Zigbee, etc. may be used.

According to an embodiment of the disclosure, according to control by the controller 140, the communicator 150 may request the server computer 200 to transmit content requested to be executed and receive, from the server computer 200, frames of the content requested to the executed. In detail, by communicating with the server computer 200 according to control by the controller 140, the wireless Internet module 152 may receive, from the server computer 200, the frames of the content or transmit, to the server computer 200, information about a frame-processing mode selected with respect to the executed content.

According to an embodiment of the disclosure, according to control by the communicator 140, the communicator 150 may receive a user input for controlling the content that is executed by the electronic device 100. In detail, the short-range communication module 153 may receive the user input for controlling the content from a controlling device controlling the content executed by the electronic device 100, according to control by the controller 140.

According to control by the controller 140, the video processor 160 may process an image signal received from the receiver 180 or the communicator 150 and output the processed image signal to the display 110.

According to an embodiment of the disclosure, the video processor 160 may include various video processing circuitry including, for example, a main buffer receiving frames corresponding to content, a decoder decoding the frames output from the main buffer, and a frame processor processing the decoded frames.

The display 110 may display, on a screen, the image signal received from the video processor 160.

The audio processor 165 may include various audio processing circuitry and convert an audio signal received from the receiver 180 or the communicator 150 into an analog audio signal and may output the analog audio signal to the outputter 170, according to control by the controller 140.

The audio outputter 170 may output the received analog audio signal through a speaker.

The receiver 180 may include various receiving circuitry and receive video (for example, a motion picture, etc.), audio (for example, a voice, music, etc.), and additional data (for example, an electronic program guide (EPG), etc.) from the outside of the electronic device 100, according to control by the controller 140. The receiver 180 may include one of or a combination of at least two of a high-definition multimedia interface (HDMI) port 181, a component jack 182, a PC port 183, and a universal serial bus (USB) port 184. The receiver 180 may further include a display port (DP), Thunderbolt, and a mobile high-definition link (MHL), in addition to an HDMI port.

According to an embodiment of the disclosure, the receiver 180 may receive content from a connected external device, according to control by the controller 140. In detail, the HDMI port 181 may receive content executed by a connected game console device, according to control by the controller 140.

The detector 190 may include various detecting circuitry and detect a voice, an image, or an interaction of a user and may include a microphone 191, a camera 192, and a light receiver 193. The microphone 191 may receive a voice of the user and may convert the received voice into an electrical signal and output the electrical signal through the controller 140. The camera 192 may receive an image (for example, consecutive frames) corresponding to a motion of a user including a gesture within a camera recognition range. The light receiver 193 may receive an optical signal (including a control signal) received from a remote controlling device. The light receiver 193 may receive the optical signal corresponding to a user input (for example, a touch input, a press input, a touch gesture, a voice, or a motion) from the remote controlling device. A control signal may be extracted from the received optical signal according to control by the controller 140.

According to an embodiment of the disclosure, according to control by the controller 140, the detector 190 may receive a user input for controlling the content executed by the electronic device 100. For example, according to control by the controller 140, the light receiver 193 may receive, from a controlling device controlling the content executed by the electronic device 100, the user input for controlling the content.

The memory 130 according to an embodiment of the disclosure may store a program for processing and controlling by the controller 140 and may store data input to the electronic device 100 or output from the electronic device 100.

The controller 140 may include various processing and/or control circuitry and control general operations of the electronic 100. For example, the controller 140 may execute one or more instructions stored in the memory 130 to perform functions of the electronic device 100 described herein.

According to an embodiment of the disclosure, the controller 140 may execute one or more instructions stored in the memory 130 to perform control operations for the operations described above to be performed. In this case, the memory 130 may store the one or more instructions executable by the controller 140.

According to an embodiment of the disclosure, the controller 140 may store one or more instructions in an internal memory provided in the controller 140 and may execute the one or more instructions stored in the internal memory provided in the controller 140 to perform the control operations for the operations described above to be performed. That is, the controller 140 may execute at least one instruction or program stored in the internal memory of the controller 140 or the memory 130 to perform a predetermined operation.

In FIG. 3, the controller 140 may include one or more processors. In this case, each of the operations performed by the electronic device 100 according to an embodiment of the disclosure may be performed by at least one of the plurality of processors.

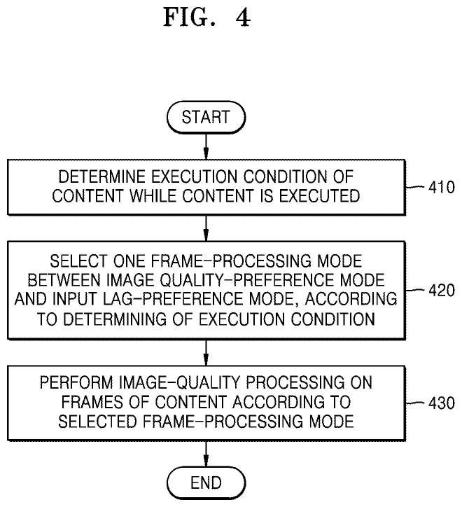

FIG. 4 is a flowchart illustrating an example method, performed by the electronic device 100, of processing frames of content according to an execution condition of the content, according to various embodiments.

Referring to FIG. 4, in operation 410, the electronic device 100 may determine an execution condition of content, while the content is executed. The content may denote content, an execution of which is controlled according to a user input, and may include, for example, game content or video content in which a scenario is changed according to a user input. Hereinafter, for convenience of explanation, an example in which the content is game content is described.

According to an embodiment of the disclosure, the electronic device 100 may execute content stored in the electronic device 100, execute content received from an external game console connected to the electronic device 100, or execute content streamed from the server computer 200.

According to an embodiment of the disclosure, the electronic device 100 may determine an execution condition of the content based on whether there is a change of scene in the executed content. In detail, the electronic device 100 may obtain an image feature of frames of the executed content, obtain a difference between the image feature of recent content frames and the image feature of previous content frames, and determine that there is the change of scene when the difference is great and determine that there is no change of scene when the difference is not great.

According to an embodiment of the disclosure, the electronic device 100 may determine the execution condition of the content based on a frequency of user inputs received in a determination period of the executed content. In detail, the electronic device 100 may obtain information about a frequency of user inputs received in a predetermined determination period of the executed content and may compare the obtained information about the frequency of the user inputs, with a threshold reference corresponding to an image quality-preference mode or a threshold reference corresponding to an input lag-preference mode. When the obtained information about the frequency of the user inputs satisfies the threshold reference corresponding to the image quality-preference mode, the electronic device 100 may determine that the execution condition of the content corresponds to the image quality-preference mode, and when the obtained information about the frequency of the user inputs satisfies the threshold reference corresponding to the input lag-preference mode, the electronic device 100 may determine that the execution condition of the content corresponds to the input lag-preference mode.

According to an embodiment of the disclosure, when it is determined that there is the change of scene in the executed content, the electronic device 100 may determine the execution condition of the content based on the frequency of the user inputs received in the determination period of the executed content. For example, the electronic device 100 may determine the execution condition of the content based on both of the feature of the content frames and the frequency of the user inputs. For example, the electronic device 100 may determine whether there is a change of scene based on the image feature of the frames of the executed content and when it is determined that there is the change of scene, may proceed to an operation of determining the frequency of the user inputs. When it is determined that there is the change of scene in the executed content, the electronic device 100 may obtain information about a frequency of user inputs received in a predetermined determination period of the executed content, and based on the obtained information about the frequency of the user inputs, may select a frame-processing mode.

In operation 420, the electronic device 100 may select one frame-processing mode of an image quality-preference mode and an input lag-preference mode according to the determining of the execution condition of the content.

According to an embodiment of the disclosure, when the electronic device 100 determines the execution condition of the content based on whether there is the change of scene of the executed content, the electronic device 100 may change the frame-processing mode when the electronic device 100 determines that there is the change of scene. For example, when a current frame-processing mode is the image quality-preference mode, the electronic device 100 may change the current frame-processing mode to the input lag-preference mode, and when the current frame-processing mode is the input lag-preference mode, the electronic device 100 may change the current frame-processing mode to the image quality-preference mode.

According to an embodiment of the disclosure, when the electronic device 100 determines the execution condition of the content based on the frequency of the user inputs received in the determination period of the executed content, the electronic device 100 may select the input lag-preference mode when the frequency of the user inputs corresponds to the input lag-preference mode and may select the image quality-preference mode when the frequency of the user inputs corresponds to the image quality-preference mode.

In operation 430, the electronic device 100 may perform image quality processing on frames of the content, according to the selected frame-processing mode.

According to an embodiment of the disclosure, when the selected frame-processing mode is the image quality-preference mode, the electronic device 100 may output a high quality frame image by processing the frames of the content by performing on the frames of the content all or most of one or more operations included in an image-quality processing operation.

According to an embodiment of the disclosure, when the selected frame-processing mode is the input lag-preference mode, the electronic device 100 may reduce an input lag by decreasing a time taken to process the frames, by processing the frames by excluding some of the one or more operations included in the image-quality processing operation.

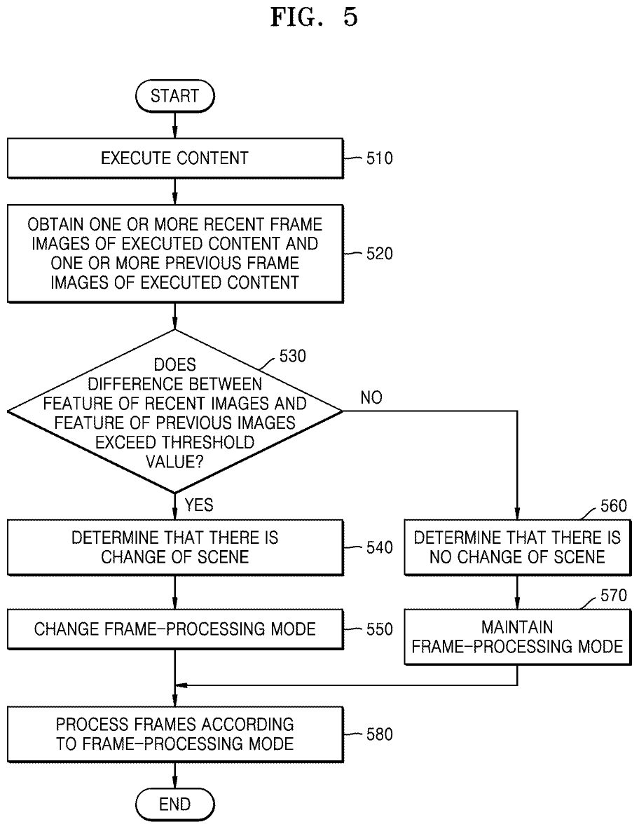

FIG. 5 is a flowchart illustrating an example method, performed by the electronic device 100, of processing content frames based on a change of scene, according to various embodiments.

Referring to FIG. 5, in operation 510, the electronic device 100 may execute content.

In operation 520, the electronic device 100 may obtain one or more recent frame images and one or more previous frame images of the executed content.

For example, the electronic device 100 may continually monitor whether or not an execution condition of the content is changed from a point at which the execution of the content is started, and may obtain one or more recent frame images and one or more previous frame images based on a predetermined time point.

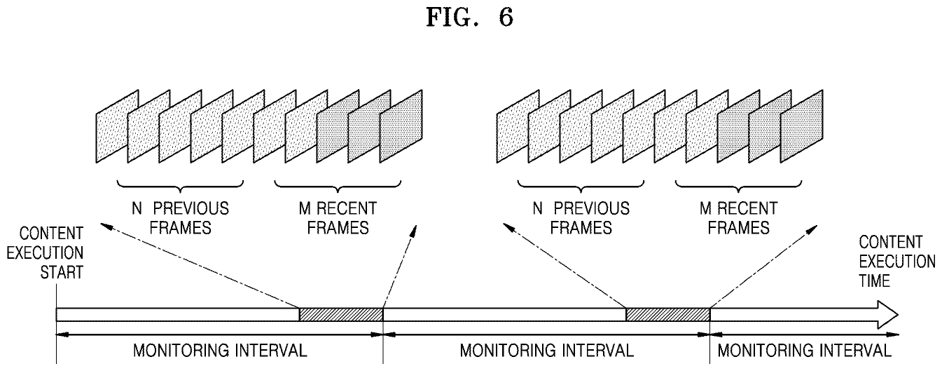

FIG. 6 is a diagram illustrating examples of one or more recent frame images and one or more previous frame images obtained by the electronic device 100, according to various embodiments.

Referring to FIG. 6, the electronic device 100 may obtain M recent frame images and N previous frame images while content is executed. Here, N and M may indicate natural numbers equal to or greater than 1. For example, the electronic device 100 may obtain three recent frame images and frame images during the previous 5 seconds before the three recent frame images.

The number of recent frame images and the number of previous frame images obtained by the electronic device 100 may be variously determined.

The electronic device 100 may continually obtain the recent frame images and the previous frame images based on a predetermined (e.g., specified) monitoring interval, from the point at which the execution of the content is started. The electronic device 100 may differently set the monitoring interval according to a title or a genre of the content. For example, in the case of content in which a change of scene is frequent, the monitoring interval may decrease, and in the case of content in which a change of scene is not frequent, the monitoring interval may increase.

Referring to FIG. 5 again, in operation 530, the electronic device 100 may determine whether a difference between a feature of the one or more recent frame images and a feature of the one or more previous frame images is greater than a threshold value.

For example, the electronic device 100 may first obtain the feature of the one or more recent frame images and the feature of the one or more previous frame images. With respect to obtaining the feature of the frame images, when the electronic device 100 obtains one frame image, the electronic device 100 may use RGB values of pixels included in the one frame image. When the electronic device 100 obtains a plurality of frame images, the electronic device 100 may use an average of RGB values of pixels included in the plurality of frame images. However, not only the average of the RGB values of the pixels included in the plurality of frame images, but also a maximum value, a minimum value, a median value, etc. may also be used. When the average of the RGB values of the pixels included in the plurality of frame images is used, it may be configured that it is not determined that there is an actual change of scene, with respect to a condition in which a difference in image feature occurs, because a unique graphics effect is temporarily added.

According to an embodiment of the disclosure, the electronic device 100 may compare an SSIM value or a PSNR value of two images as an image feature value. The SSIM is an algorithm for comparing a difference between two images by comparing the brightness, the contrast, and the structure between the two images. In addition to the SSIM, similar algorithms may include a multi-scale (MS)-SSIM, an information content weighted (IW)-SSIM, features similarity (FSIM), the gradient similarity based metric (GSM), etc.

According to an embodiment of the disclosure, the electronic device 100 may compare a color histogram of two images as an image feature value. The color histogram indicates distribution of brightness values with respect to pixels in an image.

According to an embodiment of the disclosure, the electronic device 100 may determine whether there is a difference between two images using a deep learning model (for example, fully convolutional Siamese metric networks for scene change detection) in a scene change detection field.

According to an embodiment of the disclosure, the electronic device 100 may obtain a difference between a feature value of the one or more recent frame images and a feature value of the one or more previous frame images and may determine whether the difference exceeds a threshold value.

As described above, the electronic device 100 may differently set parameter values, such as a monitoring interval, an average number of frames to be calculated, and a threshold value, which is a criterion to determine whether there is a change, depending on a title or a genre of the content. For example, when a screen is flashy and there is a frequent change even in the same situation as in the case of some music-playing game content, more reliable determination may become possible by increasing the number of frames, an average of which is to be calculated, and raising the threshold value.

When it is determined in operation 530 that the difference between the feature of the recent image and the feature of the previous image exceeds the threshold value (YES in 530), the electronic device 100 may proceed to operation 540.

In operation 540, the electronic device 100 may determine that there is the change of scene, when the difference between the feature of the one or more recent frame images and the feature of the one or more previous frame images exceeds the threshold value as described above.

In operation 550, the electronic device 100 may change a frame-processing mode, when the electronic device 100 determines that there is the change of scene. For example, when the electronic device 100 determines that there is the change of scene, the electronic device 100 may change a current frame-processing mode to an input lag-preference mode, when the current frame-processing mode is an image quality-preference mode, and may change the current frame-processing mode to the image quality-preference mode, when the current frame-processing mode is the input lag-preference mode.

When the electronic device 100 determines in operation 530 that the difference between the feature of the recent image and the feature of the previous image does not exceed the threshold value (NO in 530), the electronic device 100 may proceed to operation 560.

In operation 560, the electronic device 100 may determine that there is no change of scene, when the difference between the feature of the one or more recent frame images and the feature of the one or more previous frame images does not exceed the threshold value as described above.

In operation 570, the electronic device 100 may maintain the frame-processing mode as the current state, when the electronic device 100 determines that there is no change of scene.

In operation 580, the electronic device 100 may process the frames according to a frame-processing mode. For example, when the frame-processing mode is the input lag-preference mode, the electronic device 100 may process the frames according to the input lag-preference mode, and when the frame-processing mode is the image quality-preference mode, the electronic device 100 may process the frames according to the image quality-preference mode.

An operation of processing image qualities of the frames may include one or more detailed operations. In the case of the image quality-preference mode, the image quality of the frame is preferentially processed, and thus, all of the one or more detailed operations included in the image-quality processing operation may be performed. However, in the case of the input lag-preference mode, to reduce an input lag is preferentially processed to image quality of the frame, and thus, the image-quality processing operation may be performed by removing at least some of the one or more detailed operations included in the image-quality processing operation, to reduce the frame-processing time.

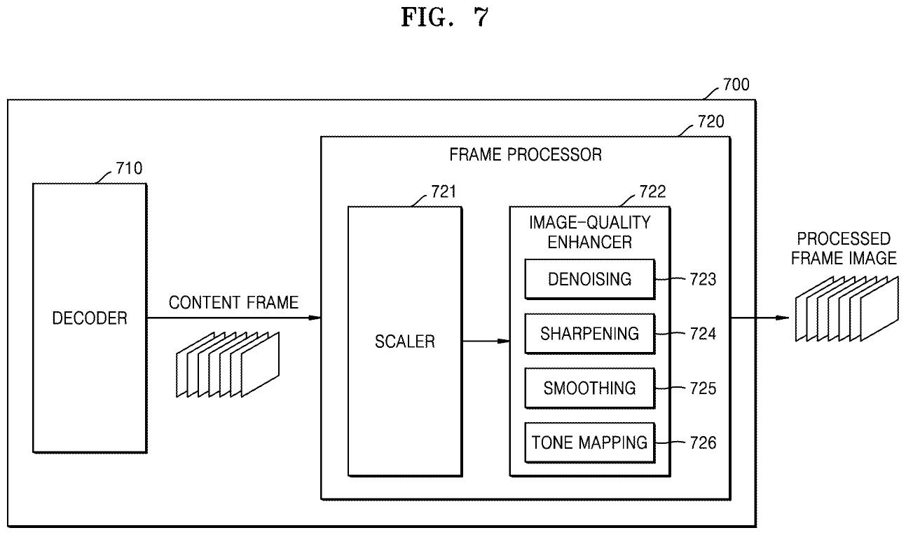

FIG. 7 is a block diagram illustrating an example an example configuration and operation of a signal processor processing a frame, according to various embodiments. A signal processor illustrated in FIG. 7 may be included, for example, and without limitation, in the controller 140 or the video processor 160 of the electronic device 100 of FIG. 3.

Referring to FIG. 7, the signal processor 700 may include a decoder 710 and a frame processor (e.g., including frame processing circuitry) 720.

The decoder 710 may perform a decoding process for decoding a content frame signal that is input. The signal decoded by the decoder 710 may be input to the frame processor 720.

The frame processor 720 may include various frame processing circuitry including, for example, a scaler 721 and an image-quality enhancer 722.

The scaler 721 may include various circuitry and/or executable program instructions and perform a scaling process for adjusting a screen size to be appropriate for a display panel.

The image-quality enhancer 722 may include various circuitry and/or executable program instructions and perform an image enhancing process for improving image quality by making an image more vivid. The image enhancing process may upgrade the image quality by increasing a contrast with respect to a deteriorated image to increase the visibility of an image that is input or decreasing the blurring, optical noise, geometric distortion, etc. Also, the image enhancing process may use sharpening for emphasizing or extracting an outline of an object by locally increasing a contrast of an image, restoring the blurring, etc. and smoothing for removing the optical noise.

Referring to FIG. 7, the image-quality enhancing operation performed by the image-quality enhancer 722 may include, for example, denoising, sharpening, smoothing, tone mapping, etc.

A denoising operation (723) may denote an operation of removing noise from an image. A parameter of the denoising operation (723) may be based on a noise removal function.

A sharpening operation (724) may denote an operation of increasing a definition of an image. The sharpening operation (724) may be based on a definition function. A smoothing operation (725) may denote a smooth blurring process operation for softly processing noise after deterioration of a high-frequency component of an image.

A tone mapping operation (726) is a signal-processing method for changing input signal information (RGB or YCbCr . . . ) of an image to a level desired by a user (a developer). For example, when the tone mapping is applied, adjustment may be made, such as making a detail of a dark portion or a bright portion of an image relatively more distinctive, emphasizing a black color, or further increasing the brightness of the bright portion.

When the electronic device 100 processes the frame according to an image quality-preference mode, the electronic device 100 may perform signal processing whereby all of the detailed processes of the image quality-enhancing operation, that is, denoising, sharpening, smoothing, and tone mapping, are performed. Thus, processing latency may occur, to drop a processing speed, but a high-quality image may be displayed.

When the electronic device 100 processes the frame according to an input lag-preference mode, the electronic device 100 may perform signal processing by omitting at least one or all of the detailed processes of the image quality-enhancing operation, that is, denoising, sharpening, smoothing, and tone mapping. In the input lag-preference mode, at least some of image-quality processing processes for improving the image quality are not performed, and thus, the image quality may be degraded, but the frame processing speed may increase, and thus, the input lag may be reduced.

The denoising, sharpening, smoothing, and tone mapping that are included in the detailed processes of the image-quality enhancing operation performed by the image-quality enhancer 722 illustrated in FIG. 7 are merely an example. The detailed processes of the image-quality enhancing operation performed by the image-quality enhancer 722 may include only one or more of the denoising, sharpening, smoothing, and tone mapping or may further include other detailed processes in addition to these processes.

Also, with reference to FIG. 7, descriptions are primarily provided with respect to whether all or part of the detailed processes is to be performed by the image-quality enhancer 722 according to the frame-processing mode. However, embodiments of the disclosure are not necessarily limited thereto. Processes performed by the scaler 721 may be divided into detailed processes which may be performed in the input lag-preference mode and detailed processes which may be performed in the image quality-preference mode, according to the frame-processing mode, and depending on each frame-processing mode, different processes may be performed. Also, the frame processor 720 may further include modules performing other processes, in addition to the scaler 721 and the image-quality enhancer 722, and these additional modules may also be realized to perform different processes depending on the frame-processing mode.

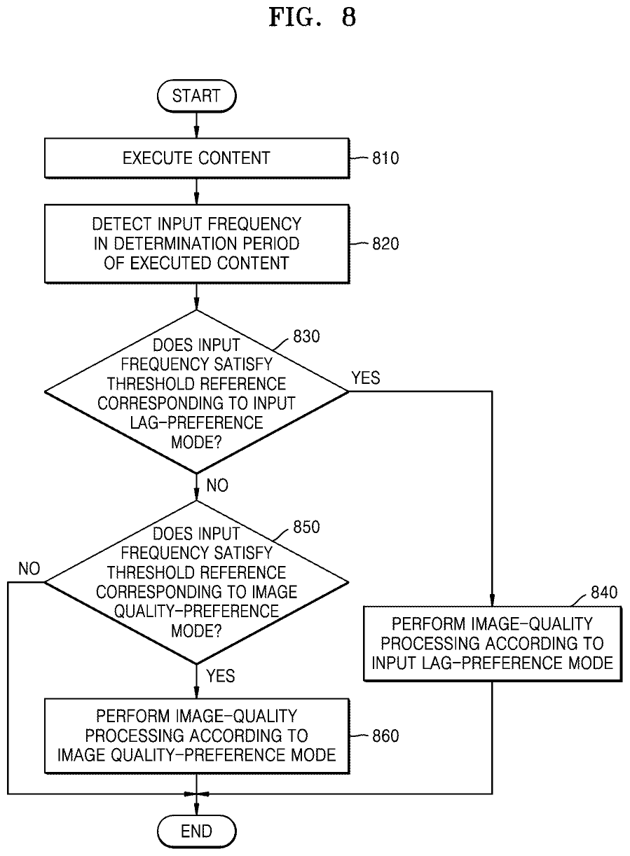

FIG. 8 is a flowchart illustrating an example method, performed by the electronic device 100, of processing content frames based on a user input frequency, according to various embodiments.

Referring to FIG. 8, in operation 810, the electronic device 100 may execute content.

In operation 820, the electronic device 100 may detect a frequency of user inputs (e.g., input frequency) for controlling the execution of the content in a determination period of the executed content. The electronic device 100 may receive the user input for controlling the execution of the content, through various user input devices. For example, the electronic device 100 may receive the user input from an input device, such as a game pad, a joystick, a keyboard, a mouse, etc., or a controlling device, such as a remote controller or a smartphone connected via communication.

According to an embodiment of the disclosure, the frequency of the user inputs may include the number of times of the user inputs received in the determination period of the content and an interval between the user inputs.

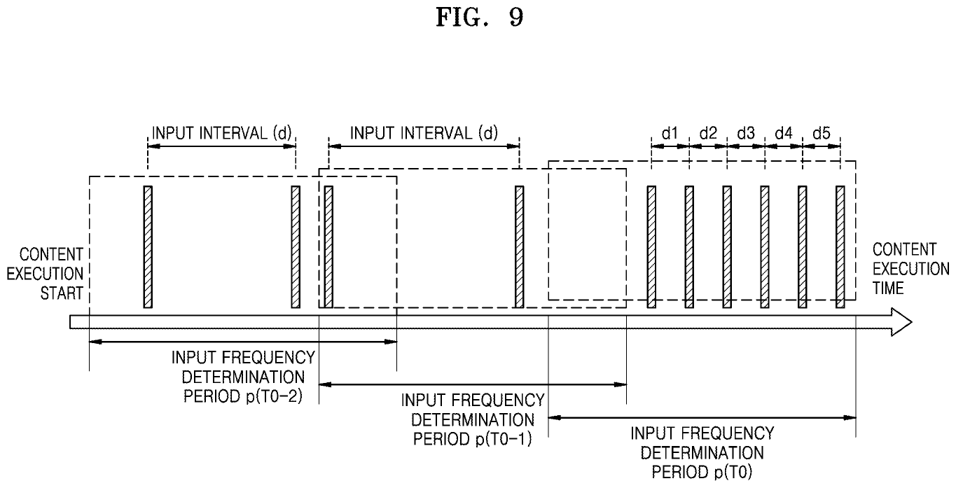

FIG. 9 is a diagram illustrating an example of frequency of user inputs received in a determination period of content, according to various embodiments.

Referring to FIG. 9, the electronic device 100 may detect a frequency of user inputs by monitoring the user inputs received in a predetermined input frequency-determination period p, after content is started to be executed. The frequency of the user inputs may include the number of times of the user inputs received in the input frequency-determination period and an interval d between the user inputs.

For example, referring to FIG. 9, the frequency of the user inputs detected in an input frequency-determination period p (T0-2) may include the number of times (2) of the user inputs and a user input interval d, the frequency of the user inputs detected in an input frequency-determination period p (T0-1) may include the number of times (2) of the user inputs and the user input interval d, and the frequency of the user inputs detected in an input frequency-determination period p (T0) may include the number of times (6) of the user inputs and user input intervals d1, d2, d3, d3, d4, and d5. When there are a plurality of input intervals as detected in the input frequency-determination period p (T0), the electronic device 100 may use an average of the plurality of input intervals.

According to an embodiment of the disclosure, when a predetermined input key is repeatedly received, the electronic device 100 may assign a weight to an input corresponding to the predetermined input key. For example, although the number of times of the user inputs received in the input frequency-determination period p (T0) is 6 in FIG. 9, the number of times of the user inputs may be determined to be 12, for example, by calculating 6*2 by assigning a weight of 2, when all of the above user inputs correspond to the same input key.

In the example illustrated in FIG. 9, the input frequency-determination period includes a temporally overlapping portion. However, it is not necessarily limited thereto, and the input frequency-determination period may be configured such that there is no temporal overlapping.

The input frequency-determination period, which may refer, for example, to a reference unit, based on which the electronic device 100 detects the input frequency, may be differently set according to a category or a genre of the content.

Referring to FIG. 8 again, in operation 830, the electronic device 100 may determine whether the input frequency detected in the determination period of the content satisfies a threshold reference corresponding to the input lag-preference mode. For example, the electronic device 100 may determine whether the number of times of inputs occurring in the determination period is greater than a threshold value Li of the number of times of the input lag-preference mode and whether an average input interval is less than a threshold value Ld of an interval of the input lag-preference mode.

A condition for determining the input lag-preference mode may include, for example, and without limitation:

the number of times of inputs occurring the determination period>the threshold value Li of the number of times of the input lag-preference mode; and

the average input interval<the threshold value Ld of the interval of the input lag-preference mode.

When the electronic device 100 determines that the number of times of inputs occurring in the determination period is greater than the threshold value Li of the number of times of the input lag-preference mode, and the average input interval is less than the threshold value Ld of the interval of the input lag-preference mode, the electronic device 100 may determine that an input lag is important with respect to the execution of the corresponding content and may select the input lag-preference mode as a frame-processing mode. The electronic device 100 may proceed to operation 840 and may process the frames according to the input lag-preference mode.

When to electronic device 100 determines that the input frequency satisfies the threshold reference corresponding to the input lag preference mode (YES in 830), the electronic device 100 may proceed to operation 840. In operation 840, the electronic device 100 may process the frames by omitting one or more of detailed processes of an image-quality enhancing operation, in order to increase a speed of processing the frames, based on the input lag-preference mode.

When the electronic device 100 determines that the input frequency does not satisfy the threshold reference corresponding to the input lag-preference mode (NO in 830), the electronic device 100 may proceed to operation 850.

In operation 850, the electronic device 100 may determine whether the input frequency detected in the determination period of the content satisfies a threshold reference corresponding to the image quality-preference mode. For example, the electronic device 100 may determine whether the number of times of inputs occurring in the determination period is less than a threshold value Qi of the number of times of the image quality-preference mode and whether the average input interval is greater than a threshold value Qd of an interval of the image quality-preference mode.

A condition for determining the image quality-preference mode may include, for example, and without limitation: the number of times of inputs occurring in the determination period<the threshold value Qi of the number of times of the image quality-preference mode; and the average input interval>the threshold value Qd of the interval of the image quality-preference mode.

When the electronic device 100 determines that the number of times of inputs occurring in the determination period is less than the threshold value Qi of the number of times of the image quality-preference mode, and the average input interval is greater than the threshold value Qd of the interval of the image quality-preference mode, the electronic device 100 may determine that image quality is more important than the input lag in the execution of the content and may select the image quality-preference mode as the frame-processing mode.

When to electronic device 100 determines that the input frequency satisfies the threshold reference corresponding to the image quality preference mode (YES in 850), the electronic device 100 may proceed to operation 860 and may process the frames according to the image quality-preference mode.

In operation 860, the electronic device 100 may process the frames by performing the detailed processes of the image-quality enhancing operation, in order to output the high quality frames, based on the image quality-preference mode.

According to an embodiment of the disclosure, the threshold values Li and Ld used for determining the input lag-preference mode and the threshold values Qi and Qd used for determining the image quality-preference mode may be differently set depending on a genre or a title of the content. For example, in the case of game content, such as first person shooting (FPS), the procedure which is mostly occupied by a battle situation, most of content frames may correspond to the input lag-preference mode. Thus, in the case of the content, most parts of which have to be processed according to the input lag-preference mode, the electronic device 100 may advantageously configure the threshold values corresponding to the input lag-preference mode, such that the input lag-preference mode is aptly determined, and may disadvantageously configure the threshold values corresponding to the image quality-preference mode, such that the image quality-preference mode is not aptly determined. For example, in the state of the image quality-preference mode, reference threshold values for determining the input lag-preference mode may be configured to be easily satisfied, and a length p of the determination period may be configured to be relatively small. In contrast, in the state of the input lag-preference mode, reference threshold values for determining the image quality-preference mode may be configured to be difficult to be satisfied, and the length p of the determination period may be configured to be relatively large.

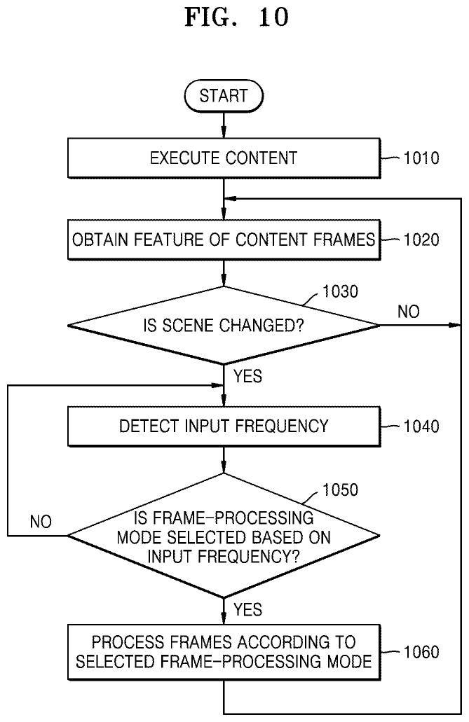

FIG. 10 is a flowchart illustrating an example method, performed by the electronic device 100, of processing frames of content by taking into account both of a change of scene and a user input frequency, according to various embodiments.

Referring to FIG. 10, the electronic device 100 may execute content in operation 1010.

In operation 1020, while the electronic device 100 executes the content, the electronic device 100 may obtain a feature of content frames of the content. In detail, the electronic device 100 may obtain one or more recent frame images and one or more previous frame images of the executed content. The electronic device 100 may obtain a feature of the one or more recent frame images and a feature of the one or more previous frame images. For the feature of the frame images, an SSIM value, a PSNR value, a color histogram, etc. may be used.

In operation 1030, the electronic device 100 may determine whether there is a change of scene of the content. For example, the electronic device 100 may obtain a difference between a feature value of the one or more recent frame images and a feature value of the one or more previous frame images and may determine whether this difference exceeds a threshold value. When the difference between the feature value of the one or more recent frame images and the feature value of the one or more previous frame images exceeds the threshold value, the electronic device 100 may determine that there is the change of scene of the content and may proceed to operation 1040. Also, when the difference between the feature value of the one or more recent frame images and the feature value of the one or more previous frame images does not exceed the threshold value, the electronic device 100 may determine that there is no change of scene of the content and may proceed to operation 1020, without even a need to check the user input frequency. For the detailed operation of operation 1030, the corresponding operations of FIG. 5 may be applied.

In operation 1040, when the electronic device 100 determines that there is the change of scene of the executed content (YES in 1030), the electronic device 100 may detect an input frequency to determine a condition based on the input frequency.

The electronic device 100 may detect a frequency of user inputs controlling the execution of the content, in a determination period of the executed content. According to an embodiment of the disclosure, the frequency of the user inputs may include the number of times of the user inputs received in the determination period of the content and an interval between the user inputs.

In operation 1050, the electronic device 100 may determine a frame-processing mode based on the input frequency. For example, the electronic device 100 may determine whether the input frequency detected in the determination period of the content satisfies a threshold reference corresponding to an input lag-preference mode or satisfies a threshold reference corresponding to an image quality-preference mode. For example, when the number of times of the inputs occurring in the determination period is greater than a threshold value Li of the number of times of the input lag-preference mode, and an average input interval is less than a threshold value Ld of an interval of the input lag-preference mode, the electronic device 100 may select the frame-processing mode as the input lag-preference mode. For example, when the number of times of the inputs occurring in the determination period is less than a threshold value Qi of the number of times of the image quality-preference mode, and the average input interval is greater than a threshold value Qd of an interval of the image quality-preference mode, the electronic device 100 may select the frame-processing mode as the image quality-preference mode. For the detailed operation of operation 1050, all of corresponding operations of FIG. 8 may be applied.

In operation 1050, when the frame-processing mode is selected (YES in 1050), the electronic device 100 may proceed to operation 1060.

In operation 1060, the electronic device 100 may process the frames of the content according to the selected frame-processing mode. When the input lag-preference mode is selected as the frame-processing mode, the electronic device 100 may process the frames by omitting some of detailed processes of an image-quality enhancing operation, in order to increase a speed of processing the frames, based on the input lag-preference mode. When the image quality-preference mode is selected as the frame-processing mode, the electronic device 100 may process the frames by performing all of the detailed processes of the image-quality enhancing operation, in order to process the frame to have a high image quality, based on the image quality-preference mode.

In operation 1050, when the frame-processing mode is not selected (NO in 1050), the electronic device 100 may proceed to operation 1040. That is, when a valid frame-processing mode is not selected based on the input frequency, despite the change of scene, the electronic device 100 may skip monitoring of the change of scene and may again determine the condition based on the input frequency.

According to various embodiments of the disclosure described above, the electronic device 100 may select the frame-processing mode based on the change of scene of the executed content or the user input frequency and may process the frames according to the selected frame-processing mode. In an example in which content is streamed to the electronic device 100 from the server computer 200, the frame-processing mode may be selected by the server computer 200, and the server computer 200 may provide information about the frame-processing mode to the electronic device 100.

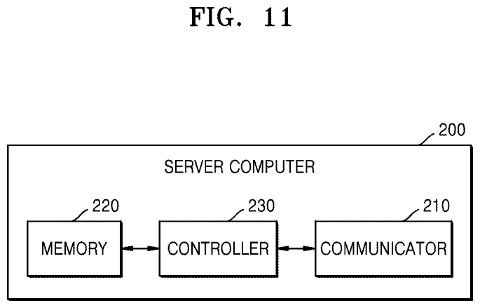

FIG. 11 is a block diagram illustrating an example configuration of the server computer 200 for providing content to the electronic device 100, according to various embodiments.

Referring to FIG. 11, the server computer 200 may include a communicator (e.g., including communication circuitry) 210, a memory 220, and a controller (e.g., including processing and/or control circuitry) 230.

The communicator 210 may include various communication circuitry and transmit content to the electronic device 100 based on a communication protocol, according to control by the controller 230.

The memory 220 may store programs connected with operations of the server computer 200 and various pieces of data generated during the operations of the server computer 200.

The controller 230 may include various processing and/or control circuitry and control general operations of the server computer 200 and may process frames of the content to be transmitted to the electronic device 100.

While the controller 230 according to an embodiment of the disclosure executes one or more instructions to transmit the content to the electronic device 100, the controller 230 may analyze a change of scene of the content and also transmit information about a frame-processing mode selected based on the change of scene. For example, the controller 230 may first select one frame-processing mode between an image quality-preference mode and an input lag-preference mode, depending on a category or a genre of the content, and may transmit, to the electronic device 100, the information about the selected frame-processing mode along with the content. Also, the controller 230 may monitor the content and detect a change of scene, and when the change of scene is significant, the controller 230 may change a current frame-processing mode and transmit information about the changed frame-processing mode to the electronic device 100.

While the controller 230 according to an embodiment of the disclosure executes one or more instructions to transmit the content to the electronic device 100, the controller 230 may receive information about the frame-processing mode from the electronic device 100, may process the frames of the content according to the received frame-processing mode, and may provide the processed frames to the electronic device 100.

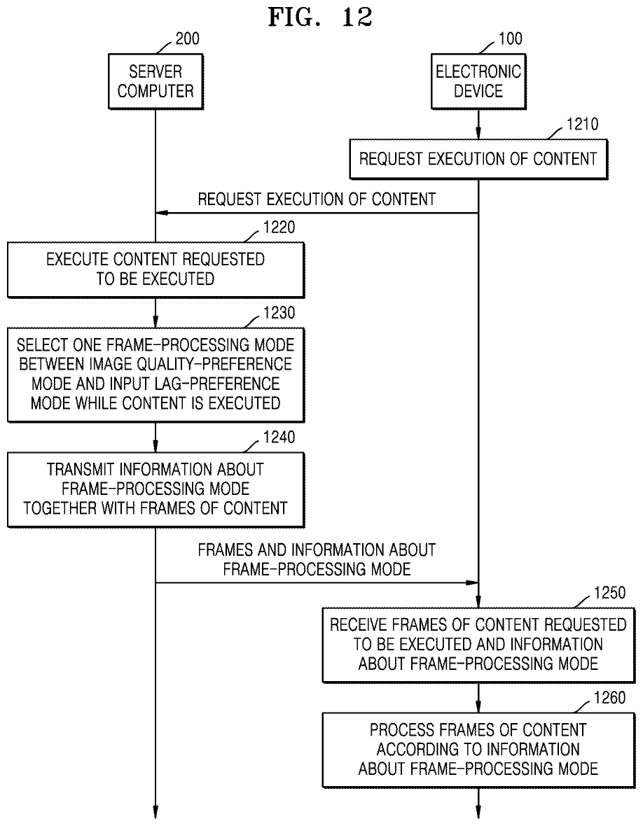

FIG. 12 is a signal flow diagram illustrating an example method, performed by the server computer 200, of providing information about a frame-processing mode to the electronic device 100, according to various embodiments.

Referring to FIG. 12, in operation 1210, the electronic device 100 may receive, from a user, a request for execution of content and transmit the request for the execution of the content to the server computer 200.

In operation 1220, the server computer 200 may execute the content requested to be executed.

In operation 1230, while the content is executed, the server computer 200 may select one frame-processing mode between the image quality-preference mode and the input lag-preference mode based on a change of scene of the executed content.

In operation 1240, the server computer 200 may transmit information about the frame-processing mode to the electronic device 100 together with frames of the executed content.

In operation 1250, the electronic device 100 may receive, from the server computer 200, the frames of the content requested to be executed and the information about the frame-processing mode.

In operation 1260, when the electronic device 100 processes the received frames of the content, the electronic device 100 may process and display the frames according to the frame-processing mode received from the server computer 200. That is, when the frame-processing mode is indicated as the image quality-preference mode, the electronic device 100 may process the frames by performing all of the detailed processes included in the image-quality enhancing operation, thereby outputting the high quality frames. When the frame-processing mode is indicated as the input lag-preference mode, the electronic device 100 may omit one or more processes of the detailed processes included in the image-quality enhancing operation, thereby reducing an input lag.

In the operations illustrated in FIG. 12, the server computer 200 may monitor the change of scene and select the frame-processing mode in real time while executing the content requested to be executed, and thus, may provide to the electronic device 100 the information about the selected frame-processing mode in real time. Based on this configuration, the electronic device 100 may not process the frames according to one frame-processing mode determined according to a category or a genre of the content requested to be executed. Rather, the electronic device 100 may process the frames by flexibly applying the image quality-preference mode and the input lag-preference mode, depending on a scene condition, and thus, may reduce the input lag and at the same time, may provide the high quality content to the user.

In the example illustrated in FIG. 12, it is described that the information about the frame-processing mode is received from the server computer 200. When the electronic device 100 receives the content from an HDMI-connected game console, the electronic device 100 may receive the information about the frame-processing mode using, for example, some fields of transition minimized differential signaling (TMDS).

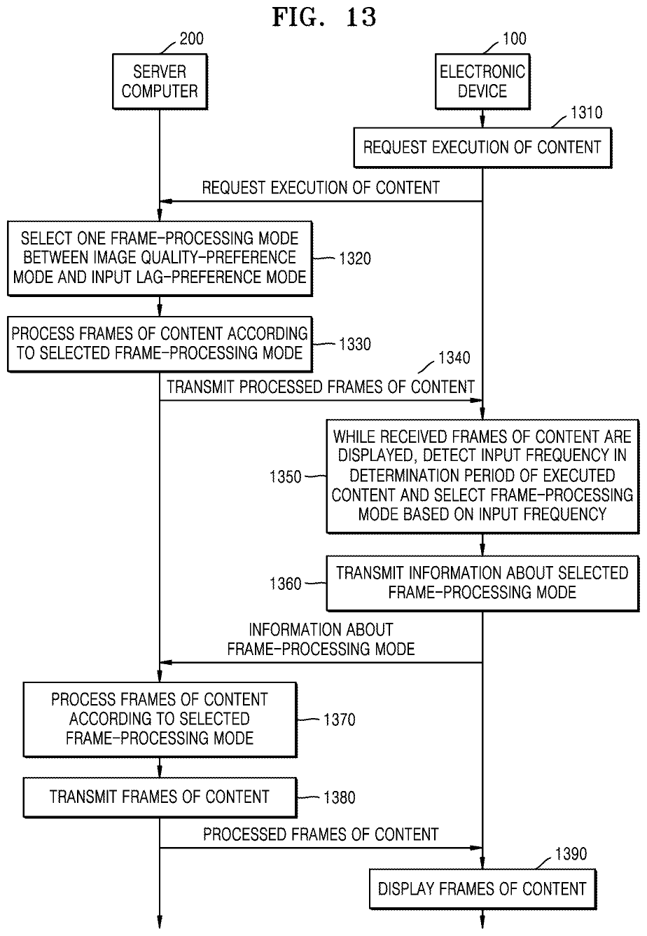

FIG. 13 is a signal flow diagram illustrating example operations in which the electronic device 100 provides information about a frame-processing mode to the server computer 200, and the server computer 200 processes content frames according to the information about the frame-processing mode and transmits the content frames to the electronic device 100, according to various embodiments.

Referring to FIG. 13, in operation 1310, the electronic device 100 may receive a request of execution of content from a user and transmit the request of the execution of the content to the server computer 200.

In operation 1320, the server computer 200 may select one frame-processing mode between the image quality-preference mode and the input lag-preference mode with respect to the content requested to be executed. For example, the server computer 200 may select one frame-processing mode between the image quality-preference mode and the input lag-preference mode, based on a category or a genre of the content requested to be executed.

In operation 1330, the server computer 200 may process the frames of the content according to the selected frame-processing mode.

According to an embodiment of the disclosure, the server computer 200 may apply a technique of performing image-quality processing for each frame included in the content, in order to adaptively perform the image-quality processing on the content, according to a feature of each of scenes. The technique of performing image-quality processing for each content frame may include, for example, HDR10+.

High dynamic range (HDR) is a technique that extends a range of brightness from the brightest level to the darkest level, to be most similar to human vision. A difference between HDR10 and HDR10+ lies in metadata including information, such as a color, a brightness, etc. contained in content, such as an image, a game, a TV application, etc. In HDR10, static metadata that applies the same color and brightness is used, even when the scene is changed, and thus, the quality of image may deteriorate in a very dark or bright scene. However, in HDR10+, dynamic metadata automatically configured for each scene may be applied, and thus, the quality of image may be optimized for each scene. That is, HDR10+ provides pixel statistical data optimized for each scene, as default information, and a reference tone mapping curve optimized for each scene, as option data. This information may assist display devices of various characteristics to uniformly display the mood of an original image.

The server computer 200 may perform the frame processing such that image-quality information, as metadata, may be inserted or not for each frame of the content, according to the selected frame-processing mode. When the frame-processing mode is the image quality-preference mode, the image quality is preferentially considered, and thus, the server computer 200 may perform the frame processing such that the metadata containing the image-quality information may be inserted for each frame of the content. However, when the frame-processing mode is the input lag-preference mode, the frame-processing time is preferentially considered, and thus, the server computer 200 may perform the frame processing such that insertion of the metadata for the frame of the content may be omitted.

In operation 1340, the server computer 200 may transmit the processed frames of the content to the electronic device 100.

In operation 1350, while the electronic device 100 displays the frames of the content received from the server computer 200, the electronic device 100 may detect an input frequency corresponding to user inputs in a determination period of the executed content and select the frame-processing mode based on the input frequency corresponding to the user inputs. The configuration of detecting the input frequency corresponding to the user inputs in the determination period of the content and selecting the frame-processing mode according to the input frequency corresponding to the user inputs is the same as or similar to the configuration described with reference to FIG. 8, and is not further described.

In operation 1360, the electronic device 100 may transmit information about the selected frame-processing mode to the server computer 200.

In operation 1370, the server computer 200 may process the frames of the content according to the selected frame-processing mode. For example, when the server computer 200 receives, from the electronic device 100, the input lag-preference mode selected as the frame-processing mode while the server computer 200 performs the frame processing such that the metadata of image-quality information may be inserted for each frame because the frame-processing mode selected in operation 1320 according to the category or the genre of the content is the image quality-preference mode, the server computer 200 may perform the frame processing by omitting the insertion of the metadata of image-quality information for each frame of the content from the corresponding time point at which the server computer 200 receives the frame-processing mode selected as the input lag-preference mode. Alternatively, for example, when the server computer 200 receives, from the electronic device 100, the image quality-preference mode selected as the frame-processing mode while the server computer 200 performs the frame processing such that the metadata of image-quality information may not be inserted for each frame because the frame-processing mode selected in operation 1320 according to the category or the genre of the content is the input lag-preference mode, the server computer 200 may perform the frame processing by inserting the metadata of image-quality information for each frame of the content from the corresponding time point at which the server computer 200 receives the frame-processing mode selected as the image quality-preference mode.

In operation 1380, the server computer 200 may transmit the processed frames of the content to the electronic device 100, and in operation 1390, the electronic device 100 may display the content frames. When the electronic device 100 receives, from the server computer 200, the frames processed according to the image quality-preference mode, the electronic device 100 may display the frames by performing image-quality processing on the frames according to the metadata of image-quality information inserted for each frame. When the electronic device 100 receives, from the server computer 200, the frames processed according to the input lag-preference mode, the electronic device 100 may display the frames by processing the frames without additionally referring to the metadata of image-quality information.

According to various embodiments of the disclosure, it is described that the image-quality processing may be performed on the content frames by adaptively determining the frame-processing mode based on the change of scene of the executed content or the frequency of the user inputs received in the predetermined determination period.

According various embodiments of the disclosure, the electronic device 100 may detect an object in a scene of the executed content and may perform the image-quality processing on the content frames by adaptively determining the frame-processing mode based on the detected object. Object detection may refer, for example, to a field of computer vision and refers to a technique that detects a significant specific object in the total digital image and video. Object detection may include, for example, a neural approach method based on a neural network and a non-neural approach method not based on a neural network. Of these, the non-neural approach method may refer, for example, to a method that obtains features for classification and then proceeds with detection using a classification technique (e.g. a support vector machine (SVM)) using the features. The neural approach method may representatively include a convolutional neural network (CNN)-based model (a CNN, a region-based CNN (R-CNN), a faster R-CNN, and DenseNet), YOLO, Retina-Net, FCOS, etc.

According to an embodiment of the disclosure, the electronic device 100 may adaptively determine the frame-processing mode, depending on whether a new object is detected in a scene of the executed content. In detail, when the new object is detected in the scene of the executed content, the electronic device 100 may convert the frame-processing mode to an input lag-preference mode and perform image-quality processing on the content frame. When the new object is detected in the scene of the content, user inputs are expected to increase according to the new object, and thus, in order to process the increasing user inputs without latency, the frame-processing mode may be determined as the input lag-preference mode.

According to an embodiment of the disclosure, the electronic device 100 may detect an object in a scene of the executed content and may adaptively determine the frame-processing mode according to a movement speed of the detected object or a level of change of the movement speed. For example, when an object is detected in the scene of the executed content, the electronic device 100 may monitor a movement speed of the detected object, and when the movement speed of the object is high or the level of change of the movement speed is high, based on a result of the monitoring, the electronic device 100 may change the frame-processing mode to the input lag-reduction mode and perform image-quality processing on the content frame. When the movement speed of the object or the level of change of the movement speed is high, user inputs are expected to increase according to the movement of the object, and thus, in order to process the increasing user inputs without latency, the frame-processing mode may be determined as the input lag-reduction mode. When the movement speed of the object is low or the level of change of the movement speed is low, based on a result of the monitoring, the electronic device 100 may convert the frame-processing mode into the image quality-preference mode and perform image-quality processing on the content frame. When the movement speed of the object or the level of change of the movement speed is low, the user inputs are not expected to increase according to the movement of the object, and thus, in order to process the frames by preferentially taking into account the image quality, the frame-processing mode may be determined as the image quality-preference mode.

According to an embodiment of the disclosure, the electronic device 100 may detect a level of change of a screen in the scene of the executed content (a level of change of a vector value extracted from an image) and may adaptively determine the frame-processing mode according to the detected level of change of the screen. The electronic device 100 may detect the level of change based on a vector value extracted from a previous screen and a vector value extracted from a current screen, and when the level of change is high, the electronic device 100 may expect increasing user inputs and may determine the frame-processing mode as the input lag-preference mode, and when the level of change is low, the electronic device 100 may expect increasing user inputs and may determine the frame-processing mode as the image quality-preference mode.

One or more embodiments of the disclosure may be implemented by a recording medium including a computer-executable instruction, such as a program module executed by a computer. Computer-readable media may be arbitrary media which may be accessed by computers and may include volatile and non-volatile media, and detachable and non-detachable media. Also, the computer-readable media may include computer storage media. The computer storage media include all of volatile and non-volatile media, and detachable and non-detachable media which are designed as methods or techniques to store information including computer-readable instructions, data structures, program modules, or other data.

The embodiments of the disclosure may be realized as a software (S/W) program including instructions stored in computer-readable storage media.

A computer may be a device for calling the instructions stored in the storage media and performing, in response to the called instructions, operations according to the embodiments of the disclosure, and may include the electronic device according to the embodiments of the disclosure.

The computer-readable storage medium may include the form of a non-transitory storage medium. Here, the term “non-transitory” may only denote that a storage medium does not include a signal and is tangible, and may not distinguish between semi-permanent and temporary storage of data in the storage medium.

Also, the controlling methods according to the embodiments of the disclosure may be included in a computer program product. The computer program product may be transacted between a seller and a purchaser.

The computer program product may include an S/W program or a computer-readable storage medium in which the S/W program is stored. For example, the computer program product may include a product in the form of an S/W program (for example, a downloadable application) that is electronically distributed through a manufacturer of a device or an electronic market (for example, a Google play store or an App store). For electronic distribution, at least a portion of the S/W program may be stored in a storage medium or temporarily generated. In this case, the storage medium may include a server of the manufacturer, a server of the electronic market, or a storage medium of a broadcasting server temporarily storing the S/W program.

In a system including a server and a device, the computer program product may include a storage medium of the server or a storage medium of the device. Alternatively, when there is a third device (for example, a smartphone) connected to the server or the device for communication, the computer program product may include a storage medium of the third device. Alternatively, the computer program product may directly include an S/W program transmitted from the server to the device or the third device or transmitted from the third device to the device.

In this case, any one of the server, the device, and the third device may perform the method according to the embodiments of the disclosure by executing the computer program product. Alternatively, at least two of the server, the device, and the third device may perform the method according to the embodiments of the disclosure in a distributed fashion by executing the computer program product.

For example, the server (for example, a cloud server or an artificial intelligence (AI) server) may execute the computer program product stored in the server to control the device connected to the server for communication to perform the methods according to the embodiments of the disclosure.

As another example, the third device may execute the computer program product to control the device connected to the third device for communication to perform the method according to the embodiments of the disclosure. When the third device executes the computer program product, the third device may download the computer program product from the server and execute the downloaded computer program product. Alternatively, the third device may execute the computer program product provided in a pre-loaded state to perform the method according to the embodiments of the disclosure.

Also, in this disclosure, a “unit” may refer to a hardware component, such as a processor or a circuit, and/or a SAN component executed by a hardware component such as a processor.

The above descriptions of the disclosure are examples, and it would be understood by one of ordinary skill in the art that the disclosure may be easily modified as other specific forms without changing the technical concept or essential features of the disclosure. Hence, it will be understood that the embodiments of the disclosure described above are examples in all aspects and are not limiting of the scope of the disclosure. For example, each of components described as a single unit may be executed in a distributed fashion, and likewise, components described as being distributed may be executed in a combined fashion.

The scope of the disclosure is not limited by the detailed description of the disclosure, and it should be understood that the claims and all modifications or modified forms drawn from the concept of the claims are included in the scope of the disclosure.

What is claimed is:

1. An electronic device comprising:
a communication interface comprising communication circuitry;
a memory storing one or more instructions; and
a processor, when executing the one or more instructions stored in the memory, is configured to:
while content is executed, identify an execution condition of the content;
select a frame-processing mode between an image quality-preference mode and an input lag-preference mode based on the identifying of the execution condition, the image quality-preference mode being a frame processing mode in which processing is performed by taking into account image quality of the content preferentially to an input lag of the content, and the input lag-preference mode being a frame processing mode in which processing is performed by taking into account the input lag of the content preferentially to the image quality of the content; and
perform image-quality processing on frames of the content according to the selected frame-processing mode.

2. The electronic device of claim 1, wherein the processor is further configured to: determine whether there is a change in the execution condition by comparing a feature of one or more recent frame images of the executed content with a feature of one or more previous frame images of the executed content.

3. The electronic device of claim 2, wherein the processor is further configured to:
determine whether a difference between a feature value obtained with respect to the one or more recent frame images and a feature value obtained with respect to the one or more previous frame images exceeds a threshold value;
based on the difference exceeding the threshold value, change a current frame-processing mode by determining that there is the change in the execution condition; and
based on the difference not exceeding the threshold value, maintain the current frame-processing mode by determining that there is no change in the execution condition.

4. The electronic device of claim 3, wherein the feature value obtained with respect to the one or more recent frame images comprises a feature value obtained from an average of information about the one or more recent frame images, and
the feature value obtained with respect to the one or more previous frame images comprises a feature value obtained from an average of information about the one or more previous frame images.

5. The electronic device of claim 3, wherein the feature value comprises at least one of a structural similarity index map (SSIM), a peak signal-to-noise ratio (PSNR), or a color histogram.

6. The electronic device of claim 3, wherein a number of frame images used for obtaining the feature value, a period for determining whether there is the change in the execution condition of the content, and the threshold value are differently set based on a title or a genre of the executed content.

7. The electronic device of claim 1, wherein the processor is further configured to select the frame-processing mode based on a frequency of inputs received in a determination period of the executed content.

8. The electronic device of claim 7, wherein the frequency of the inputs comprises a number of times the inputs are received in the determination period and an interval between the inputs received in the determination period.

9. The electronic device of claim 8, wherein the processor is further configured to:
based on the number of times of the inputs received in the determination period being greater than a threshold value of a number of times of the input lag-preference mode, and the interval between the inputs being less than a threshold value of an interval of the input lag-preference mode, select the input lag-preference mode; and
based on the number of times of the inputs received in the determination period being less than a threshold value of a number of times of the image quality-preference mode, and the interval between the inputs being less than a threshold value of an interval of the image quality-preference mode, select the image quality-preference mode.

10. The electronic device of claim 9, wherein the threshold value of the number of times of the input lag-preference mode, the threshold value of the interval of the input lag-preference mode, the threshold value of the number of times of the image quality-preference mode, and the threshold value of the interval of the image quality-preference mode are differently set based on a title or a genre of the executed content.

11. The electronic device of claim 1, wherein the processor is further configured to:
based on the selected frame-processing mode being the image quality-preference mode, perform a specified number of image quality-enhancing operations on the frames of the content; and
based on the selected frame-processing mode being the input lag-preference mode, remove one or more image quality-enhancing operations from among the specified number of image quality-enhancing operations and perform remaining image quality-enhancing operations on the frames of the content.

12. The electronic device of claim 1, wherein the processor is further configured to:
based on the executed content being streamed from a server, provide information about the selected frame-processing mode to the server; and
receive, from the server, content frames on which image-quality processing is performed based on the selected frame-processing mode.

13. The electronic device of claim 1, wherein the processor is further configured to:
determine whether there is a change of scene based on features of frame images of the executed content;
based on determining that there is the change of scene, detect a frequency of inputs received in a determination period of the executed content; and
based on the frequency of the inputs received in the determination period, select a frame-processing mode between the image quality-preference mode and the input lag-preference mode.

14. A method of operating an electronic device, comprising:
while content is executed, identifying an execution condition of the content;
selecting a frame-processing mode between an image quality-preference mode and an input lag-preference mode, based on the identifying of the execution condition, the image quality-preference mode being a frame-processing mode in which processing is performed by taking into account image quality of the content preferentially to an input lag of the content, and the input lag-preference mode being a frame-processing mode in which processing is performed by taking into account the input lag of the content preferentially to the image quality of the content; and
performing image-quality processing on frames of the content based on the selected frame-processing mode.

15. The method of claim 14, further comprising determining whether there is a change in the execution condition by comparing a feature of one or more recent frame images of the executed content with a feature of one or more previous frame images of the executed content.

16. The method of claim 15, further comprising:
determining whether a difference between a feature value obtained with respect to the one or more recent frame images and a feature value obtained with respect to the one or more previous frame images exceeds a threshold value;
based on the difference exceeding the threshold value, changing a current frame-processing mode by determining that there is the change in the execution condition; and
based on the difference not exceeding the threshold value, maintaining the current frame-processing mode by determining that there is no change in the execution condition.

17. The method of claim 14, further comprising selecting the frame-processing mode based on a frequency of inputs received in a determination period of the executed content.

18. The method of claim 17, further comprising:
based on the number of times of the inputs received in the determination period being greater than a threshold value of a number of times of the input lag-preference mode, and the interval between the inputs being less than a threshold value of an interval of the input lag-preference mode, selecting the input lag-preference mode; and
based on the number of times of the inputs received in the determination period being less than a threshold value of a number of times of the image quality-preference mode, and the interval between the inputs being less than a threshold value of an interval of the image quality-preference mode, selecting the image quality-preference mode.

19. The method of claim 14, further comprising:
determining whether there is a change of scene based on features of frame images of the executed content;
based on determining that there is the change of scene, detecting a frequency of inputs received in a determination period of the executed content; and
based on the frequency of the inputs received in the determination period, selecting a frame-processing mode between the image quality-preference mode and the input lag-preference mode.

20. A non-transitory computer-readable recording medium having recorded thereon a program comprising one or more instructions which, when executed on a computer, cause an electronic device to perform operations comprising:
while content is executed, identifying an execution condition of the content;
selecting a frame-processing mode between an image quality-preference mode and an input lag-preference mode, based on the identifying of the execution condition, the image quality-preference mode being a frame-processing mode in which processing is performed by taking into account image quality of the content preferentially to an input lag of the content, and the input lag-preference mode being a frame-processing mode in which processing is performed by taking into account the input lag of the content preferentially to the image quality of the content; and
performing image-quality processing on frames of the content based on the selected frame-processing mode.
